(19) United States
(12) Patent Application Publication
(10) Pub. No.: US 2023/0382806 A1
(43) Pub. Date: Nov. 30, 2023

(54) FOAM CERAMICS, FOAM CERAMICS FILTERS, METHOD FOR THE PRODUCTION AND USE THEREOF

(71) Applicant: DRACHE UMWELTTECHNIK GMBH, Diez (DE)

(72) Inventors: Phillip Aisa Streck, Diez (DE); Alexander Mach, Diez (DE)

(21) Appl. No.: 18/032,673

(22) PCT Filed: Oct. 20, 2021
(86) PCT No.: PCT/EP2021/079135

§ 371 Date: Apr. 19, 2023

(30) Foreign Application Priority Data
Oct. 20, 2020 (DE) 10 2020 127 583.8

(51) Int. Cl. C04B 35/10; B01D 39/20; C22B 21/06; C04B 38/06; C04B 35/64

(52) U.S. Cl. CPC C04B 35/10; B01D 39/2093; C22B 21/066; C04B 38/0615; C04B 35/64; B01D 2239/10; C04B 2235/3217; C04B 2235/3418; C04B 2235/349; C04B 2235/365; C04B 2235/3409; C04B 2235/447; C04B 2235/606; C04B 2235/9607

(57) ABSTRACT

The invention generally relates to foam ceramics (3) and to filters comprising such a foam ceramic, and to a method for producing foam ceramics and filters comprising or made of such a foam ceramic. Another aspect relates to the use of the foam ceramic (3) and of a filter comprising or made of such a foam ceramic.

### FIELD OF THE INVENTION

The disclosure generally relates to foam ceramics and to filters comprising such a foam ceramic, as well as to a method for producing foam ceramics and filters comprising or made of such a foam ceramic. Another aspect relates to the use of the foam ceramic and of a filter comprising or made of such a foam ceramic.

### BACKGROUND OF THE INVENTION

Foam ceramics are used, for example, as filter materials for filtering molten metal. In particular, it has long been known that foam ceramics containing Al₂O₃ are used to filter melts of non-ferrous metals such as aluminum or aluminum alloys.

In the context of the present disclosure, ceramic is generally understood to mean an inorganic, non-metallic, polycrystalline material. A ceramic is typically obtained in a process or can be produced by a process which comprises the steps of providing a mixture of raw materials including a powdered inorganic material, forming a usually aqueous slip (or a slurry or suspension), shaping a green body, and firing the green body. The firing of the green body to form a ceramic material usually includes a sintering process. Ceramics may have a structure in a form so as to comprise a base material which makes up the majority of the ceramic, i.e. at least 50 wt %, in particular at least 60 wt %, and usually consist of grains or comprise grains such as crystal grains or crystallites or crystals or aggregates of crystals or crystallites, for example Al₂O₃, such as α-Al₂O₃, i.e. corundum. In addition to the base material, ceramics may comprise a further phase that at least partially surrounds and binds together the individual grains of the base material. This further phase, in which the grains of the base material of the ceramic are embedded, is referred to as the matrix within the context of the present disclosure. The matrix can in particular comprise a binding agent or binder or may be in the form of a binding agent or binder. The matrix generally comprises at least one binding agent. However, it is generally also possible for the matrix to comprise a mixture of binding agents. The matrix can also be in the form of a binding agent or even consist of the binding agent. However, it is also possible that the matrix comprises constituents of the base material in addition to the binder, for example in the form of base material that has been partially melted and incorporated into the matrix.

In the context of the present disclosure, a binding agent or a binder is understood to be a substance in a mixture of substances which forms bonds to other constituents of the mixture of substances at the interface, here for example at the phase or grain boundaries of the grains of the base material, and is thus able to bond to one another, for example by adhesion and/or cohesion, and/or to crosslink these constituents, here the grains of the base material.

In the context of the present disclosure, a foam ceramic is understood to be a ceramic having a foam-like structure. A foam ceramic may in particular be configured so as to comprise an open, continuous porosity so as to allow a fluid material to pass from a first side of a body comprising such a foam ceramic through the pores of the foam ceramic to a second side of the body, preferably a side of the body opposite the first side of the body. Such a foam ceramic and correspondingly such a foam are also referred to as “open-cell”. Such foam ceramics can be defined by their density, which is usually specified as a relative density, and by the pore size. The relative density is given by the ratio of the measured density of the foam ceramic to the theoretical density of a ceramic without porosity, which has an identical composition in terms of the solid material. Typical measured densities of foam ceramics can range from 0.25 to g/cm³. The pore size of a foam ceramic is usually given as the number of pores in relation to a length, for example as pores per centimeter, or as ppi (pores per inch). The larger this value, the smaller the pores.

Foam ceramics which include aluminum oxide and aluminum phosphate as constituents have long been used for the filtration of molten aluminum or aluminum alloys. In this case, the aluminum phosphate acts as a binder which at least partially surrounds and bonds together the aluminum oxide particles of the base material, so that such a foam ceramic can also be described as comprising a core or base material comprising crystalline aluminum oxide, often in the form of α-Al₂O₃, for example in the form of calcined α-Al₂O₃, and a matrix comprising a binder which comprises phosphate or a binder comprising phosphate, and the matrix, i.e. here the phosphate comprising matrix, at least partially surrounds and bonds together the core or base material or the grains forming this material, or the grains this material consists of. Thus, the matrix comprises at least one phosphate comprising binding agent here. Such foam ceramics are also referred to as phosphate-bonded foam ceramics or phosphate-bonded alumina-based foam ceramics. In the case of phosphate-bonded foamed ceramics, monoaluminum dihydrogen phosphate Al(H₂PO₄)₃ is generally added to the slip, which converts to aluminum phosphate AlPO₄ during firing of the ceramic.

Although such foam ceramics and filters made of or comprising such phosphate-bonded foam ceramics have been established on the market for many years, they have a number of disadvantages. What is unfavorable, for example, is the usually quite high coefficient of thermal expansion of the ceramic material, which is or can range between about 8.5*10⁻⁶/K and 8.9*10⁻⁶/K, in combination with a high modulus of elasticity and only low thermal conductivity, and the only low thermal shock resistance resulting therefrom. The thermal conductivity of the filter material is very difficult to measure due to the porous, partially amorphous and/or polycrystalline structure of the filter material. During the filtration process, the phosphate matrix may also be attacked by the melt, so that the mechanical strength of the foam ceramic is further reduced. Furthermore, after having been used as a filter material, such foam ceramics also produce or may produce monophosphane, a toxic gas which is particularly problematic for the disposal of used filters. Moreover, particle release often occurs with conventional foam ceramics, which is also referred to as “snow” or “chalking” or commonly as snowing. Depending on the type of binding agent used, a 17″ filter weighing between approx. 3.3 kg and 4.0 kg may produce a particle release of up to 1.2 g, which corresponds to a material loss of 0.36‰ due to snowing or chalking. Even though at first glance this is only a minor loss of material from the filter material, it is nevertheless very disadvantageous because these released particles can, for example, also migrate into the casting and then adversely affect it in terms of its properties.

Another common problem in light metal casting, for example in the production of aluminum castings, is in particular the occurrence of pores in the aluminum casting. These are usually caused by hydrogen, which is the only soluble gas in an aluminum melt. Studies have shown that the choice of filter material can influence and specifically minimize the formation of pores. For example, Fankhanel et al. (Erzmetall 71 (2019), page 32 ff.) describe that the formation of pores can be reduced by a filter comprising a mixed oxide ceramic comprising 15 wt % of spodumene, LiAlSi₂O₆, and 85 wt % of Al₂O₃, compared to a pure Al₂O₃ filter material. This is attributed to the formation of LiAlH₄, so that the formation of gaseous hydrogen which causes pore formation can at least be reduced.

However, the spodumene-containing filter material proposed by Fankhanel et al. is unfavorable, because spodumene undergoes a phase transformation during the production of large-format foam ceramics. This results in cracking after firing of the foam ceramic. Furthermore, spodumene has a low coefficient of thermal expansion compared to Al₂O₃. Due to the differences in the coefficients of thermal expansion between this low-expansion phase and Al₂O₃, thermomechanical stresses will occur in the material, which can ultimately lead to mechanical failure of the filter due to fracture.

Furthermore, various foam ceramics have been proposed as replacements for the known phosphate-bonded foam ceramics. For example, U.S. Pat. No. 8,518,528 B2 discloses a foam ceramic for use as a filter material, for example for casting aluminum, the foam ceramic comprising an aluminosilicate-containing core or base material, namely Al₂SiO₅, in particular kyanite, and a glassy material containing boron oxide, which surrounds the core or base material. The glassy material at least partially surrounds and bonds together the grains of the base material, and this in particular in the form of a continuous, coherent material. The problem of pore formation due to hydrogen is not addressed, but at least the filter material can be made more environmentally friendly in this way, since the phosphate, which is unfavorable from a disposal and environmental point of view, is dispensed with. However, these filter materials also exhibit notable chalking/snowing. In particular, a comparison of the foam ceramics according to U.S. Pat. No. 8,518,528 B2 and conventional phosphate-bonded foam ceramics shows that the latter exhibit significantly greater release of particles. For example, a test showed that a 17″ filter made of a foam ceramic according to U.S. Pat. No. 8,518,528 B2 resulted in a particle release of 1.2 g. A 17″ filter made of a phosphate-bonded foam ceramic, by contrast, lost only 0.03 g. Particle release from a filter material or a foam ceramic is not only disturbing, because the casting can be contaminated with particles in this way and can be adversely affected with regard to the resulting properties of the casting. The particle release is in fact also directly related to the strength of the foam ceramic.

The lower the snowing, the greater is the strength of the foam ceramic. The problem of hydrogen outgassing is addressed in practice, for example, by degassing units such as those compared in a study by Chesonis et al., Metal Quality Comparison of Alcan Compact Degassers and SNIF at Alcoa Mount Holly Casthouse. The hydrogen concentration is determined once upstream of the degasser and once downstream of the degasser. The casting rate is approx. 36 kg/hour, here.

The hydrogen contents determined in the above study at the taphole are between 0.24 and ml per 100 g. Downstream of the degasser, values between only 0.14 and 0.18 ml per 100 g are obtained. A drawback of this process is that an additional component, the degasser, is absolutely necessary in the casting process. Also, the hydrogen values obtained in the aluminum melt are still relatively high, so that overall it would be desirable to further reduce the hydrogen content. EP 3 508 461 A1 discloses a foam ceramic comprising Al₂O₃ as a base material and colloidal SiO₂ as a binder. The foam ceramic can also comprise a borate glass and/or boron oxide as a further binder. In this way, a filter material is obtained which exhibits a lower absorption of magnesium after filtration of magnesium-containing alloys. According to EP 3 508 461 A1, the foam ceramic material described there is also said to have a lower tendency to release particles compared to filters with aluminum silicates as a component of the base material. However, this document also does not address the problem of pore formation in a casting as caused by hydrogen. Furthermore, due to the silicate binder, it can also be assumed that the snowing behavior of the foam ceramics described in EP 3 508 461 A1 is inferior to that of known phosphate-bonded foam ceramics.

There is therefore a need for foam ceramics for use as a filter material in metal casting, in particular in light metal casting, for example in the casting of aluminum or alloys containing aluminum and/or magnesium, as well as for methods for producing such foam ceramics, which at least reduce pore formation in metal castings and/or with less particle release and/or with enhanced mechanical strength and/or improved environmental compatibility, as well as for methods for producing such foam ceramics. There is also a need for filters for the casting of non-ferrous metals, which comprise such foam ceramics.

### OBJECT OF THE INVENTION

The object of the invention is to provide a foam ceramic which at least partially overcomes the problems of the prior art. Further aspects relate to the provision of a filter comprising such a foam ceramic and to a manufacturing method for such foam ceramics and generally to the use of the foam ceramic.

### SUMMARY OF THE INVENTION

The object is achieved by the subject-matter of the independent claims. Specific or preferred embodiments are specified in the dependent claims and the further disclosure.

Accordingly, the invention relates to a foam ceramic which comprises a base material comprising Al₂O₃ and preferably Li₂O and a matrix comprising SiO₂ and/or B₂O₃ and/or P₂O₅ and/or Li₂O and/or CaO, wherein the coefficients of thermal expansion of the base material and of the matrix preferably differ from one another by not more than 6*10⁻⁶/K, preferably by at most 5*10⁻⁶/K, more preferably by at most 4*10⁻⁶/K, yet more preferably by at most 3*10⁻⁶/K, and most preferably by at most 2*10⁻⁶/K.

Such a configuration is extremely advantageous.

This is because a base material comprising Al₂O₃ generally exhibits very good chemical stability, in particular for the case where the foam ceramic should be suitable for use as a filter material in metal casting, for example in light metal casting such as the casting of aluminum melts or aluminum-containing melts. This is because it is known that Al₂O₃, for example in the form of calcined Al₂O₃, exhibits good resistance in contact with aluminum melts. The base material is preferably present as a particulate phase.

Furthermore, the foam ceramic comprises a matrix comprising SiO₂ and/or B₂O₃ and/or P₂O₅ and/or Li₂O and/or CaO. For example, the matrix may comprise silicic acid as a binder, for example in the form of pyrogenic silicic acid. However, it is also possible and may even be preferred for the matrix to comprise a colloidal silica sol as a binding agent. In this case, in fact, the slip can be produced in a particularly simple manner, in particular using such a silica sol as is marketed under the name Levasil, for example, but also other commercially available silica sols. Such a configuration of the matrix as described above can be advantageous in particular for reducing the firing temperature, and hence from a cost and environmental point of view. For example, B₂O₃ can be effective as a flux to lower a melting or sintering temperature, for example. B₂O₃ is therefore another optional constituent of the matrix. However, alternatively or additionally, the matrix may also be configured so as to comprise P₂O₅, (so-called phosphate-comprising matrix). P₂O₅ is a known constituent of binding agents for ceramics, such as foam ceramics, in particular as a constituent of aluminum phosphate. Such foam ceramics having a matrix that at least partially comprises phosphate exhibit only low particle release, i.e. they have high strength. However, since phosphate-bonded ceramics are unfavorable from the point of view of environmental protection and occupational safety, the foam ceramic according to one embodiment is advantageously designed such that the matrix contains further constituents in addition to P₂O₅, in particular SiO₂ and/or B₂O₃ and/or Li₂O and/or CaO. A particularly preferred constituent of the matrix can be Li₂O. Another particularly preferred constituent of the matrix can be CaO.

In other words, according to one embodiment, a foam ceramic is provided which comprises an Al₂O₃-comprising base material and a matrix, and the foam ceramic comprises Li₂O. Li₂O can be present either as a constituent of the base material or as a constituent of the matrix or of a phase forming the matrix. It has been found that such an embodiment of a foam ceramic surprisingly significantly improves the strength of the foam ceramic. In particular, the particle release can be reduced even further compared to standard foam ceramics, i.e. phosphate-bonded foam ceramics.

It is unclear what this improvement in strength is caused by. It could be that Li₂O as a constituent of the matrix leads to a better bond between the particles of the base material, i.e. improves the cohesion of the material through a stronger bond.

According to a further embodiment, a foam ceramic is provided which comprises an Al₂O₃-comprising base material and a matrix, and the foam ceramic comprises CaO. In particular the matrix comprises CaO. It has been found that particularly good strength of the foam ceramic can also be achieved with such an embodiment. This can in particular be achieved if the foam ceramic furthermore includes in particular B₂O₃ and/or SiO₂, preferably B₂O₃ and SiO₂, in addition to CaO.

It has also been found that an embodiment of the foam ceramic comprising a base material which comprises Al₂O₃ and preferably Li₂O and a matrix which comprises SiO₂ and/or B₂O₃ and/or P₂O₅ and/or Li₂O and/or CaO permits to obtain a particularly homogeneous coefficient of thermal expansion. In particular, it seems possible to enable such a configuration by providing a certain content of CaO in the matrix.

Preferably, the coefficients of thermal expansion of the base material and of the matrix differ from each other by not more than 6*10⁻⁶/K, preferably by at most 5*10⁻⁶/K, more preferably by at most 4*10⁻⁶/K, yet more preferably by at most 3*10⁻⁶/K, and most preferably by at most 2*10⁻⁶/K. As a result thereof, fewer thermomechanical stresses will arise at the interface between the base material or at the interface between the grains which form or make up the base material and the matrix, when the foam ceramic is subjected to a temperature load which occurs, for example, when a filter comprising the foam ceramic is heated for metal casting. In other words, the parasitic particle release known from other filter materials can be further reduced in this way in a surprisingly simple manner. Consequently, this also allows to obtain metal castings, in particular light metal castings such as castings made of aluminum or aluminum alloys, with less particle ingress and hence improved quality when such a foam ceramic is used as a filter material.

In other words, according to one embodiment, a foam ceramic is provided in which the coefficient of thermal expansion of the base material and the coefficient of thermal expansion of the matrix are matched to each other such that they differ only very slightly. In this way, the foam ceramic has a resulting coefficient of thermal expansion that is very homogeneous.

In the context of the present disclosure, coefficient of thermal expansion, or a, refers to the coefficient of linear thermal expansion which is given as a mean value in the temperature range from 20° C. to 700° C., unless expressly stated otherwise. The designations α and α₂₀₋₇₀₀ as well as thermal expansion coefficient and coefficient of linear thermal expansion are used synonymously within the scope of the present disclosure. The value given is the nominal mean coefficient of linear thermal expansion. As far as it is determined for a glass within the scope of the present disclosure, the determination is carried out according to ISO 7991. For the ceramic or foam ceramic, the determination is made using PU strips which are soaked in the respective slip and then fired. After firing, the ceramic strips are measured to determine the coefficient of linear thermal expansion.

In order to obtain a resulting thermal expansion coefficient of the foam ceramic that is particularly homogeneous, it can be advantageous if the coefficients of thermal expansion of the base material and of the matrix differ from each other as little as possible. It is in particular possible for the thermal expansion coefficients of the base material and the matrix to be the same within the limits of measurement accuracy.

The inventors assume that the observed very homogeneous coefficient of thermal expansion of the foam ceramic according to one embodiment could possibly be due to an advantageous composition of the foam ceramic. In particular the content of Li₂O and/or Cao in the foam ceramic could be advantageous here.

According to one embodiment, the foam ceramic therefore comprises Li₂O, and preferably the content of Li₂O in the foam ceramic is at least 0.3 wt % and in particular preferably at most 5 wt %, most preferably not more than 0.5 wt %. On the one hand, as explained above, it has been found that the presence of Li₂O in the foam ceramic can minimize the occurrence of pores or bubbles in castings, for example aluminum castings or castings made of aluminum alloys or aluminum-containing alloys. That is why the Li₂O content of the foam ceramic is at least 0.3 wt %. This is what ensures that the number of bubbles in the casting is noticeably reduced and hence sufficient gettering of hydrogen from the non-ferrous metal melt is occurring. However, the Li₂O content of the foam ceramic should not be too high, since Li₂O is an expensive raw material. Also, as an alkali oxide, Li₂O is known to reduce the temperature stability of materials. Therefore, according to one embodiment, the content of Li₂O in the foam ceramic is at most 5 wt %, preferably even not more than 0.5 wt %. Surprisingly, however, it turned out that some content of Li₂O in the foam ceramic not only allows to reduce the formation of bubbles in a casting. Rather, highly surprisingly, this also permits to further improve the strength of a foam ceramic. This becomes apparent by the fact that the chalking/snowing of the Li₂O-containing foam ceramics is further reduced, even compared to known strong foam ceramics such as phosphate-bonded foam ceramics. This even makes it possible to obtain a high-strength foam ceramic which does not contain any P₂O₅. At least, however, the P₂O₅ content of a foam ceramic can be reduced when adding Li₂O to the foam ceramic. This is surprising in particular since it was known that foam ceramics which include a Li₂O-containing mineral as a constituent, namely spodumene, can in fact reduce the formation of bubbles in a casting, but at the same time, such foam ceramics were not sufficiently mechanically stable, which can be attributed to the phase transformation of spodumene in the temperature range in which the foam ceramics are used.

According to one embodiment, the foam ceramic comprises at least 0.1 wt % of Cao and preferably at most 20 wt % of CaO, more preferably at most 10 wt % of CaO, and most preferably not more than 2 wt % of CaO. This is particularly advantageous for the formation of a very strong foam ceramic.

According to one embodiment, the foam ceramic comprises at least 67 wt % of Al₂O₃ and preferably at most 95 wt % of Al₂O₃. The foam ceramic preferably comprises at least 72 wt % of Al₂O₃. According to a further embodiment it is intended that the foam ceramic comprises at least 75 wt % and at most 95 wt % of Al₂O₃. Al₂O₃ is an essential constituent of the foam ceramic according to the present disclosure, in particular an essential constituent of the base material. This is because, as already mentioned above, Al₂O₃ has a very good resistance in typical application cases of foam ceramics such as the filtration of molten metal such as molten aluminum. However, the proportion of Al₂O₃ must not be too high either. In order to ensure sufficient mechanical strength of the foam ceramic, it is in particular necessary to add at least one binding agent which is included in the matrix and is adapted to bond the grains of the base material to each other during firing. The at least one binding agent usually comprises a substance that is able to form bonds to the grains of the base material at the firing temperatures, and may in particular comprise at least one flux, i.e. an agent that lowers the melting or sintering temperature. However, due to the high melting temperature of Al₂O₃, the latter is not suitable as a flux, therefore an excessive content of Al₂O₃ in the foam ceramic is disadvantageous. Although it is possible to obtain an almost pure Al₂O₃ ceramic at very high firing temperatures, this is difficult to achieve in an economically sensible way, since the high firing temperatures would result in high manufacturing costs. Therefore, the content of Al₂O₃ in the foam ceramic is preferably limited and is preferably not more than 95 wt %.

As far as the composition of the foam ceramic and/or the content of a specific component and/or a specific constituent in the foam ceramic is discussed within the context of the present disclosure, this always relates to the solids content of the foam ceramic. So, the pores are not taken into account when specifying the chemical and/or mineralogical crystallographic composition in percent by weight or percent by volume.

According to one embodiment, the foam ceramic comprises between at least 5 wt % of SiO₂ and preferably at most 25 wt % of SiO₂, for example not more than 20 wt % of SiO₂.

SiO₂ is a constituent that has a very high temperature resistance. SiO₂ can in particular be provided as a binder or a constituent of a binder, for example if it is added to the slip or suspension in the form of silicic acid. In order to ensure sufficient mechanical strength of the foam ceramic through adequate bonding or cementing of the grains of the base material, the SiO₂ content of the foam ceramic should not be too low and is preferably at least 5 wt %, more preferably at least 10 wt %. However, an excessively high content of SiO₂ in the foam ceramic can also be disadvantageous. In particular, it is possible that, in contact with melts of non-ferrous metals, SiO₂ will be attacked by the latter and will dissolve or will at least partially be dissolved. This may lead to contamination of, for example, non-ferrous metal melts and is therefore unfavorable. That is why the SiO₂ content of the foam ceramic is preferably limited and, according to one embodiment, is at most 25 wt %, for example approximately 20 wt %.

According to one embodiment, the foam ceramic comprises more than 15 wt % of SiO₂, in particular more than 18 wt % of SiO₂, preferably more than 19 wt % of SiO₂, and most preferably more than 20 wt % of SiO₂.

The present disclosure therefore also relates to a foam ceramic comprising an Al₂O₃-comprising base material and a SiO₂-comprising matrix, in particular a foam ceramic according to embodiments of the present disclosure, which foam ceramic comprises more than 15 wt % of SiO₂, in particular more than 18 wt % of SiO₂, preferably more than 19 wt % of SiO₂, and most preferably more than 20 wt % of SiO₂, and preferably not more than 25 wt % of SiO₂.

According to one embodiment, the foam ceramic comprises between at least 0.1 wt % of B₂O₃ and preferably at most 5 wt % of B₂O₃. A preferred range for the B₂O₃ content may be at least wt % and preferably at most 1.5 wt %. B₂O₃ is a known flux and is therefore advantageous for lowering the sintering temperature. The temperature at which the foam ceramic is fired can therefore be lowered if the foam ceramic comprises B₂O₃. It can be advantageous if the B₂O₃ content of the foam ceramic is at least 0.1 wt % B₂O₃, preferably at least 0.3 wt %, and most preferably at least 0.5 wt %. However, the B₂O₃ content should not be too high either, otherwise the thermal stability of the foam ceramics would be too strongly impaired. Therefore, the B₂O₃ content of the foam ceramic is preferably limited and, according to one embodiment, is not more than preferably at most 5 wt %, more preferably at most 1.5 wt %.

However, it is also possible and, according to one embodiment, can even be particularly preferred if the foam ceramic is essentially free of boron. According to the disclosure, a substantially boron-free embodiment means that the B₂O₃ content of the foam ceramic is at most 500 ppm by weight (0.05 wt %), preferably less, for example at most 300 ppm (0.03 wt %), or at most 200 ppm (0.02 wt %), or at most 100 ppm (0.01 wt %). In this case, B₂O₃ will be present as a trace constituent.

Such an embodiment of the foam ceramic is possible, for example, by using a slip to which no B₂O₃-containing starting materials such as a borate glass, boron oxide, and/or boric acid are added. B₂O₃-containing starting materials are generally understood to mean starting materials in which boron or B₂O₃ is an essential constituent, i.e. not just a trace and/or an unavoidable impurity. A B₂O₃-containing starting material is present if the starting material has a B₂O₃ content of more than 1 wt %.

B₂O₃ is not just a flux that can be used to lower the sintering temperature. Rather, it is also able to protect any SiO₂ matrix that may be present from an aluminum melt, so that some content of B₂O₃ in the foam ceramic is particularly advantageous if the foam ceramic also comprises SiO₂. Alternatively, it may be advantageous for the slip used to produce the foam ceramic to comprise B₂O₃, in particular when the foam ceramic is designed so as to comprise SiO₂, without the resulting foam ceramic necessarily also having to include B₂O₃.

For example, B₂O₃ can be added to a ceramic powder to produce the slip or slurry in the form of boron oxide or boric acid. However, this can be unfavorable since, for example, boron oxide B₂O₃ can cause a silica sol to gel, so that the rheology of the slip is unfavorable. It can therefore be advantageous if other boron-comprising substances are used as starting materials instead of boron oxide or boric acid, which, unlike the aforementioned boron compounds, do not cause the aforementioned undesirable reactions in the slip, or if they do, then to a much lesser extent.

B₂O₃ which acts as a flux and can therefore lower the sintering or firing temperature of a ceramic, which is advantageous from the viewpoint of cost-effective production, should generally be a constituent of the matrix. Surprisingly, however, it has been found that it is also possible that the slip comprises B₂O₃, but not the foam ceramic obtained from a B₂O₃-comprising slip. The inventors assume that this could be attributed to the fact that B₂O₃ is effective as a flux in this case and therefore has a positive influence on the sintering of the ceramic, but volatilizes in the further course of the sintering process. In particular, this may also be related to a reaction with other components or constituents of the slip or the foam ceramic, for example in the case of a slip that comprises Li₂O and B₂O₃ in the formation of volatile or readily soluble borates.

The present disclosure therefore also relates to a foam ceramic comprising a base material which comprises Al₂O₃ and a matrix which comprises SiO₂, in particular a foam ceramic according to embodiments of the present disclosure, in which the B₂O₃ content of the foam ceramic amounts to not more than 500 ppm by weight.

According to a further embodiment, the foam ceramic is free of P₂O₅ apart from unavoidable traces. In other words, according to one embodiment this is a foam ceramic that is not phosphate-bonded. In the context of the present disclosure, unavoidable traces are understood to mean a content of P₂O₅ in the foam ceramic of at most 500 ppm of P₂O₅.

As mentioned above, phosphate-bonded foam ceramics based on Al₂O₃ as the base material and aluminum phosphate, for example monoaluminum orthophosphate, as a binder are in fact well-established materials, for example for the filtration of melts comprising aluminum, and high-strength foam ceramics can indeed be achieved with these. However, during the filtration of such alloys, aluminum phosphide and/or—in the case of melts of magnesium-containing alloys—magnesium phosphide may be formed, each of which can react with water, for example, to form monophosphane PH₃ after use. In order to avoid the formation of this hazardous substance, in particular in view of a simplified disposal of the filter materials, a design of the foam ceramic as a non-phosphate-bonded foam ceramic can therefore be advantageous.

According to a further embodiment, the foam ceramic is implemented as a phosphate-bonded foam ceramic, with a P₂O₅ content of the foam ceramic of not more than 10 wt % and preferably at least 5 wt %. According to one embodiment, the P₂O₅ content is at most 7 wt % and preferably at least 5 wt %. In this way, a foam ceramic can be obtained which has good strength, but the content of P₂O₅ in this foam ceramic is reduced in comparison with conventional foam ceramics, so that disposal problems due to the formation of monophosphane can at least be mitigated in this way.

It can be advantageous in this case, if the foam ceramic also includes Li₂O, in particular as a constituent of the matrix.

According to one embodiment, the foam ceramic is adapted such that the base material comprises α-Al₂O₃. Alpha-Al₂O₃, i.e. corundum, exhibits high thermal stability and is the most stable modification of Al₂O₃. Moreover, it is available in large quantities and is therefore preferred from the point of view of cost and in view of good availability. Preferably, α-Al₂O₃ can be provided in the form of calcined α-Al₂O₃.

As explained above, a content of the constituent Li₂O in the foam ceramic is advantageous if the foam ceramic is used as a filter material for the casting of non-ferrous metals. Therefore, a foam ceramic has been proposed, which comprises spodumene, for example.

Fankhanel et al. assume that the gettering of hydrogen in spodumene-containing foam ceramics takes place according to the following equation:

LiAlSi₂O₆+4Al+4H→LiAlH₄+2Al₂O₃+2Si

In other words, in purely mathematical terms, four hydrogen atoms can thus be gettered for one formula unit of spodumene, LiAlSi₂O₆. Here, LiAlH₄ is a solid reaction product and therefore does not contribute to the formation of pores in the casting.

Despite this favorable influence on the formation of pores in castings, with Fankhanel et al. not only describing that there is an overall reduction in the proportion of pores, but also that the remaining pores are finer and better distributed, further investigations have shown that spodumene-comprising foam ceramics cannot be used in practical applications. This is because spodumene undergoes a phase transformation when the ceramic is sintered. This means that the production of large-format filters is not feasible. This is because there is a jump in volume during the phase transformation from 3.2 g/cm³ to 2.4 g/cm³.

Surprisingly, it has been found that this negative effect can be avoided if other lithium-containing starting materials are used, namely in particular lithium-containing starting materials which do not have a phase jump at manufacturing temperatures, i.e. during the sintering of the foam ceramic, and/or lithium-containing starting materials which do not come in the form of lithium-containing chain silicates.

Suitable lithium-containing starting materials include, for example, lithium-containing island silicates such as eukryptite, or lithium-containing phyllosilicates, also known as sheet silicates, such as petalite, or preferably inorganic non-siliceous lithium compounds such as, for example, mixed oxides comprising lithium oxide and at least one other metal oxide, for example lithium-aluminum spinel, or lithium-containing salts, for example lithium carbonate. However, it is also possible for the lithium-containing starting material to come in the form of an amorphous material, for example as a lithium-comprising flux, for example as a lithium-containing glass flux or as a lithium-containing glass frit, and the glass may also be a silicate glass, for example a borosilicate glass. The lithium-containing starting materials are preferably adapted so as to be free of fluorine apart from unavoidable traces, i.e. to have contents of at most 500 ppm by weight, preferably less.

This is surprising since these materials, for example lithium-containing phyllosilicates such as lepidolite K(Li,Al)₃[(F,OH)₂](Si,Al)₄O₁₀, order petalite LiAlSi₄O₁₀ have a stratified or layered structure and are known for their ability to intercalate molecules between the individual layers of silicate anions resulting from the corner bonding of SiO₄⁴-tetrahedra, and for their very good swelling ability. It was therefore assumed that the use of such lithium-containing phyllosilicates would be disadvantageous for the stability of the foam ceramics, in particular that the ceramic would break when the foam ceramic was fired, due to the expulsion of water.

In addition, the chemical equation for gettering hydrogen using, for example, petalite as a lithium source is less favorable in comparison with the reaction resulting for spodumene. For petalite, this reaction results mathematically as follows:

3LiAlSi₄O₁₀+20Al+12H→3LiAlH₄+10Al₂O₃+12Si.

Hence, in purely mathematical terms, 4 formula units of hydrogen can again be gettered for one formula unit of the lithium-containing mineral, in this case petalite. However, the chemical equation is less favorable with regard to the by-products formed. As the chemical equation shows, more than 6 formula units of metallic aluminum are used for one formula unit of petalite in this reaction—in contrast to only 4 formula units in the similar reaction with spodumene. Also, twice as much metallic silicon is released.

A similar reaction with lepidolite appears to be even more critical at first glance, because in this case potassium can possibly also get into the melt and contaminate it during the reaction. In particular the fluorine content of lepidolite is also disadvantageous here.

However, practical tests have surprisingly shown that, despite the use of lithium-containing phyllosilicates as the starting material in the production of a foam ceramic and as a constituent of the base material, none of the aforementioned difficulties actually arise. The inventors are of the opinion that this is due to the fact that only a small part of the lithium is available for the getter reaction, namely in particular that which is arranged at the interface of the foam ceramic. In particular, it is possible that the exact type of lithium-containing phase used, in particular the exact type of crystal phase or mineral used, is less important for the formation mechanism of LiAlH₄. The inventors assume that this could be due to the fact that at least part of the relatively mobile lithium migrates from the crystalline phase of the base material into the matrix during the firing process.

Therefore, advantageously, besides lithium-containing phyllosilicates such as in particular petalite, other lithium-containing starting materials which are not in the form of lithium-containing chain silicates can also be used, for example materials which can be effective as a flux, such as salts comprising lithium oxide, or mixed oxides, for example lithium aluminates. In fact, advantageously, no lithium-containing crystalline phase is formed here either, nor is any lithium-containing crystalline phase detectable as such. Rather, in this case, the lithium in particular appears to be a constituent of the matrix that at least partially surrounds the particles of the base material. However, it is also possible for lithium to be present at least partially in the form of a mixed crystal and thus also to be a constituent of the base material.

According to one embodiment, the matrix is at least partially glassy.

A glassy configuration of the matrix is understood to mean that the matrix is formed to be amorphous and is preferably obtained by an at least partial melting process.

Such a configuration of the matrix as at least partially glassy can be particularly advantageous. On the one hand, particularly good wetting of the grains of the base material can be achieved with at least partial melting of at least one binder phase. On the other hand, a glass usually has no internal structures such as grain boundaries, at which penetration of for instance corrosive substances might occur. In other words, an at least partially glassy nature of the matrix leads to the foam ceramic as a whole becoming more stable. On the one hand, the at least partially glassy nature of the matrix leads to better bonding of the base material and thus increases its cohesion. On the other hand, the corrosive attack is reduced due to the formation of an at least partially glassy matrix which is preferably inert to the materials that come into contact therewith, such as liquid non-ferrous metals and other constituents or components of such melts, such as corrosive gases, since this makes it at least more difficult for corrosive media to pass through to the base material due to the lack of interfaces.

According to one preferred embodiment, the matrix comprises Li₂O. Such a configuration is advantageous because in this way there will be lithium present for gettering hydrogen at the interface between the foam ceramic and a melt of a metal, preferably of a non-ferrous metal, which comes into contact therewith, in particular a melt of aluminum or of an aluminum alloy.

According to one embodiment, the matrix comprises a lithium-containing silicate glass and/or a lithium-containing borate glass, preferably a lithium-containing borosilicate glass. Such an embodiment can be particularly advantageous, because it guarantees not only the advantages of a glassy nature of the matrix and the availability of lithium at the interface of the foam ceramic, at which the latter can come into contact with any possible hydrogen-containing metal melt. Rather, such an embodiment may also be particularly advantageous with respect to the formation of a foam ceramic with matched coefficients of thermal expansion of the base material and the matrix. Thus, the coefficient of thermal expansion of silicate and/or borate glasses and of borosilicate glasses can be varied through the alkali content, for example the content of lithium oxide in the glass, and can be up to more than 10*10⁻⁶/K. However, this also makes it possible to select a composition of a glass phase which has a coefficient of thermal expansion that can be adapted or matched to the coefficient of thermal expansion of the base material or to the coefficient or coefficients of thermal expansion of the material the base material is made of, i.e. in particular Al₂O₃ in the present case. Since binary alkali silicate glasses such as pure lithium silicate glass, for example, usually exhibit only very poor chemical stability, it can be advantageous to add boron oxide, B₂O₃, as a further constituent to the glass in order to increase its chemical stability. Advantageously, the firing temperature of the ceramic can also be reduced in this way.

According to a further embodiment, the foam ceramic comprises the following constituents on an oxide basis, in wt %:

| | |
|---|---|
| Al₂O₃ | 67 to 95, in particular 75 to 95 |
| Li₂O | 0 to 5, preferably 0.3 to 5, preferably 0.3 to 0.5 |
| SiO₂ | 0 to 25, preferably 5 to 25, preferably 10 to 25 |
| B₂O₃ | 0 to 5, preferably 0.1 to 5, preferably 0.3 to 1.5 and/or |
| | with a content of B₂O₃ of at most 500 ppm by weight |
| CaO | 0 to 20, preferably 0.1 to 20, preferably 0.1 to 10, more |
| | preferably 0.1 to 2 |
| P₂O₅ | 0 to 10, preferably at most 10 wt %, more preferably |
| | at most 7 wt %, most preferably at most 5 wt % |

According to a further embodiment, the foam ceramic comprises the following constituents on an oxide basis, in wt %:

| | |
|---|---|
| Al₂O₃ | 75 to 95 |
| Li₂O | 0 to 5, preferably 0.3 to 5, preferably 0.3 to 0.5 |
| SiO₂ | 0 to 25, preferably 5 to 25, preferably 10 to 25 |
| B₂O₃ | 0 to 5, preferably 0.1 to 5, preferably 0.3 to 1.5 and/or |
| | with a content of B₂O₃ of at most 500 ppm by weight |
| CaO | 0 to 20, preferably 0.1 to 20, preferably 0.1 to 10, more |
| | preferably 0.1 to 2 |
| P₂O₅ | 0 to 10, preferably at most 10 wt %, more preferably |
| | at most 7 wt %, and most preferably at most 5 wt %. |

Thus, in the context of the present disclosure, the specification of the constituents relates to the chemical composition of the material. Therefore, if a foam ceramic comprises, for example, 90 wt % of Al₂O₃ in the context of the present disclosure, this is understood to refer to the total content of aluminum oxide in the foam ceramic. In this case, the foam ceramic may comprise Al₂O₃ both in the form of Al₂O₃ and in the form of other compounds, for example in the form of an aluminum silicate.

According to yet another embodiment, the foam ceramic comprises the following constituents based on the solids content, in vol %:

| | |
|---|---|
| α-Al₂O₃ (corundum) | 85 to 95 |
| Quartz | 0.8 to 2 |
| Cristobalite | 0 to 2. |

In addition to these constituents mentioned, the foam ceramic may comprise further crystalline phases, for example AlPO₄. According to one embodiment, the foam ceramic comprises AlPO₄ in crystalline form, with a content of crystalline AlPO₄ in the foam ceramic of preferably at least 3.5 vol % and preferably not more than 9 vol %, more preferably not more than 8 vol %, most preferably not more than 7.5 vol %.

It has been found that such an embodiment is very advantageous.

Corundum is the main constituent of the foam ceramic according to this embodiment, so that such a foam ceramic exhibits very good chemical resistance, especially for use as a filter material in the casting of aluminum.

Furthermore, according to this embodiment, the foam ceramic comprises quartz, in particular deep quartz, in contents of 0.8 vol % to at most 2 vol %, and optionally cristobalite, with the content of cristobalite in the foam ceramic being limited and preferably amounting to at most 2 vol %. This is advantageous because the coefficient of thermal expansion of cristobalite is again significantly greater than that of crystalline quartz, and since in the case of cristobalite it is precisely in the range between 200° C. and 300° C. that there is a significant increase in thermal expansion. The thermal expansion in this temperature range is lower for quartz, but significantly greater than for amorphous SiO₂ (silicic acid), for example. The coefficient of thermal expansion of quartz is usually given as greater than 10*10⁻⁶/K, for example between 12 and 16*10⁻⁶/K. This is already significantly higher than the thermal expansion coefficient of corundum, which is about 8*10⁻⁶/K. The inventors assume that the thermal expansion coefficient of cristobalite, which is even greater than that of quartz, may cause the thermal expansion coefficients of the base material and the matrix to differ too much, which can lead to reduced strength of the foam ceramic, which becomes evident by so-called chalking/snowing, for example.

For example, it has been found, as will be explained again below with reference to diffractograms of selected foam ceramics in FIGS. 1 to 3, that conventional phosphate-bonded foam ceramics contain more cristobalite than quartz. In other words, a higher-expansion material predominates in the matrix there. Although conventional foam ceramics are already quite strong, they still exhibit a certain amount of particle release. The latter can at least be reduced with foam ceramics according to embodiments of the present disclosure.

By comparison, a silicate-bonded foam ceramic, the phase content of which is shown in FIG. 2 by way of example, shows a significantly increased proportion of quartz compared to cristobalite. However, this foam ceramic contains only very little corundum and in particular kyanite and boromullite as the dominant crystal phases. With regard to the chemical resistance of the foam ceramic to molten aluminum, for example, this is disadvantageous. Due to the use of silicic acid as a raw material and also taking into account the high amorphous content (visible as an elevated background at low 20 values, also referred to as “amorphous hump”), it can furthermore also be assumed that a high proportion of amorphous SiO₂ should be present here. This material has a very low coefficient of thermal expansion. These silicate-bonded foam ceramics exhibit high particle release and therefore only low strength. It is assumed that this is or could be due in particular to the unfavorable ratio of the thermal expansion coefficients of the base material (about 7*10⁻⁶/K) and the matrix (which is likely to have a high content of low-expansion constituents such as amorphous SiO₂).

Within the context of the present disclosure, a constituent of the foam ceramic is understood to be a solid phase that forms part of the foam ceramic, for example a glassy phase or a crystalline phase.

According to a further embodiment, the foam ceramic has a resulting coefficient of linear thermal expansion of at least 7*10⁻⁶/K, preferably at least 7.5*10⁻⁶/K, and preferably of at most 9*10⁻⁶/K, more preferably at most 8.5*10⁻⁶/K.

The present disclosure also relates to a method for producing a foam ceramic, preferably a foam ceramic according to embodiments of the present disclosure, comprising the following steps:
Providing a preferably aqueous slip comprising a starting material comprising Al₂O₃ and a starting material comprising SiO₂ and/or B₂O₃ and/or P₂O₅ and/or Li₂O and/or CaO;
Soaking an open-cell foam, in particular an open-cell polymer foam, with the slip, so as to obtain a foam coated with the slip: This can preferably be done in a roller mill impregnation process, for example with profiled rollers. This is particularly advantageous because it allows for a particularly uniform impregnation of the foam in an efficient manner. The uniform impregnation of the foam with the materials forming the ceramic thereby advantageously contributes to a mechanically stable foam ceramic;
Drying the foam so as to obtain a green body of a foam ceramic: The drying can be performed at elevated temperatures of around 100° C., for example. This is because the water present in the slip can evaporate quickly in this way. Temperatures higher than 100° C. can also be chosen, but should not be too high in order to avoid degeneration of the plastic foam. Drying temperatures of less than 140° C. are particularly advantageous here;
Preferably coating the dried green filter, i.e. spraying viscous sprayable slip onto the dried green filter;
Preferably burning out the polymer foam; and
Sintering the green body to obtain a foam ceramic, which can advantageously be performed at temperatures between 850° C. and 1300° C. for durations of preferably at least one hour up to preferably at most four hours. The heating and cooling times during the burnout can each preferably be at least 10 minutes and up to 100 minutes.

In the context of the present disclosure, slip is understood to mean the mixture comprising the powdered starting material or materials and a liquid phase, in particular an aqueous phase, for the production of a ceramic. The slip can also be referred to as a slurry or suspension.

In the context of the present disclosure, a green body is understood to be an unfired blank. In particular, the green body can be understood as a blank obtained by slip casting and bonded by a binder, wherein the binder can in particular also be an organic binder.

Silicate glass is understood to be an amorphous material obtained by a melting process, which comprises SiO₂ as a network former.

Borate glass is understood to be an amorphous material obtained by a melting process, which comprises B₂O₃ as a network former.

Glasses which include SiO₂ and B₂O₃ as network formers are often referred to as borosilicate glasses.

In the context of the present disclosure, the term network former is understood in the sense of Zachariasen.

According to another embodiment, the slip comprises a silicate glass or borate glass frit, preferably a borosilicate glass frit.

This is particularly advantageous because, in this way, B₂O₃ as a constituent of the foam ceramic reduces the firing temperature, as mentioned above, but the use of starting materials which can lead to gelation of the slip and thus to an unfavorable rheology, for example a strong increase in viscosity of the slip, is avoided.

In the context of the present disclosure, glass frit is understood to mean in particular a powdery, glassy material obtained by a melting process with final quenching of the liquid melt and a subsequent comminution process, for example grinding. Such glass powders can in particular be employed as a binder, for example for enamel paints, or as solder glass for producing joints between components to be joined.

The use of frit as the starting material for the matrix of a ceramic can also be advantageous because the process previously carried out during the production of the frit has already resulted in an intimate mixing of the constituents of the frit at the molecular level, namely through the melting of the starting materials of the molten glass together with the subsequent refining and homogenization of the melt. In other words, the use of a frit, for example a glass frit, at least reduces the occurrence of major inhomogeneities in the foam ceramic, for example in the matrix of the foam ceramic. This is because in a glass melt, homogenization and uniform distribution of the individual constituents of the batch used for glass production already occur during the melting process.

According to a further embodiment, the slip comprises a lithium-containing starting material, preferably a lithium-containing starting material that does not constitute or does not comprise a lithium-containing chain silicate, in particular lithium-containing island silicates such as eucryptite, or lithium-containing phyllosilicates, such as petalite; or in particular inorganic non-siliceous lithium compounds such as mixed oxides comprising lithium oxide and at least one other metal oxide, for example lithium-aluminum spinel, or lithium-containing salts, for example lithium carbonate, or a lithium-containing flux, for example a lithium-containing glass flux or a lithium-containing glass frit, wherein the glass can be a silicate glass, for example also as borosilicate glass, wherein the lithium-containing starting materials preferably come in a form that is free of fluorine apart from unavoidable traces, i.e. with fluorine contents of at most 500 ppm by weight, preferably less, most preferably as a lithium-containing phyllosilicate and/or a lithium-containing glass.

This is particularly advantageous for producing a lithium-containing foam ceramic. The lithium-containing starting material preferably comes in the form of a phyllosilicate and/or a lithium-containing glass. In other words, it is also possible and may even be preferred for the slip to comprise more than one lithium-containing starting material.

The addition of a lithium-containing starting material is particularly advantageous for producing a foam ceramic which is suitable for reducing bubbles in castings from non-ferrous metal melts.

The use of a lithium-containing phyllosilicate and/or of a lithium-containing glass is advantageous here, because this prevents the formation of phases with unfavorable coefficients of thermal expansion and/or with phase transformations within the range of the application temperature, for example the formation of spodumene. In particular, it is possible in this way to reduce the formation of a crystalline lithium-containing phase. This is understood to mean that no lithium-containing crystalline phase can be identified in an X-ray diffractogram. However, it cannot be ruled out that the lithium at least partially forms a solid solutions with other crystalline phases included in the foam ceramic. However, this is not evident from the diffractogram. However, the inventors assume that lithium is likely to be present predominantly as a constituent of an amorphous matrix. This is at least suggested by X-ray studies in which foam ceramics of different compositions, in particular with regard to the matrix, were examined and compared with one another. For example, while a conventional phosphate-bonded foam ceramic has a very low amorphous content, the amorphous content of a foam ceramic comprising Li₂O, for example, is increased. Corresponding X-ray diffractograms are shown in the following figures.

According to a further embodiment, the slip does not comprise any B₂O₃-containing starting material, for example no borate glass, no boron oxide, and/or no boric acid. B₂O₃-containing starting materials are generally understood to be starting materials which contain boron or B₂O₃ as an essential constituent, i.e. not merely as a trace and/or an unavoidable impurity. A B₂O₃-containing starting material is present if the starting material has a B₂O₃ content of more than 1 wt %.

The slip may also comprise further starting materials.

For adjusting of the rheology of the slip in a targeted manner, the latter may, for example, comprise one or more further substances. For example, the slip may in particular comprise a clay mineral such as bentonite to adjust the rheology. Additives, such as liquefiers, may also be added to improve the processability of the slip. Such additives are known to those skilled in the art. They are often organic in nature and decompose during firing.

In order to ensure sufficient mechanical stability of the green body, it is also possible for the slip to comprise further starting materials, for example organic and/or polymeric binders, which provide sufficient green body strength of the unfired blank.

Also, the slip may include additives to improve the processing characteristics of the slip, for example defoamers and/or deaerators and/or additives that improve wetting of the solid.

The present disclosure furthermore also relates to a filter for filtering melts of non-ferrous metal, in particular melts of light metals, preferably aluminum-containing melts, which comprises a foam ceramic according to the embodiments described above and/or which is produced or producible by a method according to any of the above embodiments.

### EXAMPLES

The invention will now be further explained by way of examples.

### Example 1

An exemplary composition of a slip for producing a silicate-bonded foam ceramic is given in the following table, in wt %:

| | | |
|---|---|---|
| Inorganic binder | 20% | Colloidal SiO₂ (silica sol) |
| Rheological additive | 3% | Bentonite |
| Organic binder | 1.5% | Butyl methacrylate copolymer, |
| | | e.g. Luhydran |
| Main material | 40% | Calcined alumina (Al₂O₃) |
| Secondary material | 15% | Petalite |
| Inorganic binder | 5% | Borat glass frit |
| Inorganic binder | 5% | Boric acid (H₃BO₃) |

| | |
|---|---|
| Liquefier | 0.1% |
| Water | 10.4% |

Here, the borate glass frit can preferably have the following composition, in wt % on an oxide basis:

| | |
|---|---|
| SiO₂ | 53 |
| Al₂O₃ | 14.4 |
| Fe₂O₃ | 0.2 |
| MgO | 0.5 |
| B₂O₃ | 7.5 |
| Na₂O | 0.3 |
| CaO | 23 |
| K₂O | 0.4 |
| Others | 0.7. |

However, other compositions of the frit are also possible. For example, frits that do not include SiO₂ can also be used. However, such frits which only include CaO, Al₂O₂, and B₂O₃ as constituents, for example, are often very aggressive and therefore cannot be processed well. It is therefore advantageous for the borate glass frit to be in the form of a silicate borate glass frit. This also improves the processability of a slip.

Such a slip allows to obtain a foam ceramic with the following composition (data in wt %):

| | | |
|---|---|---|
| Main material | 54% | Calcined alumina (Al₂O₃) |
| Secondary material | 20% | Petalite |
| Binder | 9% | SiO₂ |
| Binder | 7% | Borate glass |
| Binder | 6% | B₂O₃ |
| Rheological additive | 4% | Bentonite |

The calcined alumina is chemically present as Al₂O₃, namely in the modification corundum (α-Al₂O₃). Surprisingly, petalite cannot be detected as such any more in an X-ray diffraction analysis. The inventors assume that during firing petalite converts so as to form part of the amorphous matrix. For example, a matrix comprising lithium may be formed in this way. Bentonite also converts during firing and becomes part of the matrix.

An exemplary chemical composition of a non-phosphate-bonded foam ceramic obtained with the slip according to the above composition is as follows, given in wt % on an oxide basis:

| Constituent | Content in wt % |
|---|---|
| Al₂O₃ | 77.9 |
| SiO₂ | 20.4 |
| TiO₂ | 0.07 |
| Fe₂O₃ | 0.14 |
| CaO | 0.16 |
| K₂O | 0.12 |
| MgO | 0.09 |
| MnO | 0.01 |
| Na₂O | 0.44 |
| B₂O₃ | 0.01 |
| Li₂O | 0.48 |
| Cr₂O₃ | 0.01 |
| P₂O₅ | 0.07 |
| V₂O₅ | <0.01 |
| ZnO | <0.01 |
| ZrO₂ | 0.06 |
| Total | 100 |
| Loss on ignition | 0.09 |

The composition was determined using RFA and ICP analysis, calculated on annealed material. The contents of the constituents B₂O₃ and Li₂O were determined using ICP-OES.

Example 1 is a foam ceramic which was obtained from a slip with a B₂O₃-containing starting material, which however only contains traces of B₂O₃. The inventors assume that a foam ceramic of such a composition can also be obtained from a slip which does not contain any B₂O₃-containing starting materials. However, it might be that it is just the use of a starting material containing B₂O₃ which brings about advantages in the microstructure of the resulting foam ceramic and/or in the manufacturing process.

### Example 2

Another exemplary composition of a slip for producing a phosphate-bonded foam ceramic is given in the table below:

| Binder | 13% | Monoaluminum phosphate (AlPO₄) |
|---|---|---|
| Liquefier system | 0.1% | |
| Water | 12% | |
| Main constituent | 61% | Calcined alumina (Al₂O₃) |
| Secondary constituent | 11% | Petalite |
| Rheological additive | 1.3% | Bentonite |
| Strength additive | 1.6% | Boehmite (AlOOH) |

Such a slip allows to obtain a foam ceramic with the following composition:

| | | |
|---|---|---|
| Binder | 7% | Monoaluminum dihydrogen phosphate |
| | | AlH₂PO₄ |
| Main constituent | 76% | Calcined alumina Al₂O₃ |
| Secondary constituent | 13.5% | Petalite |
| Rheological additive | 1.7% | Bentonite |
| Strength additive | 1.8% | Boehmite AlOOH |

Bentonite is transformed during firing and reacts with the phosphate, forming aluminum phosphate. Here, again, petalite as such is not detectable any more in an XRD.

An exemplary chemical composition of the foam ceramic obtained from a slip as given above is as follows, given in wt % on an oxide basis:

| Constituent | Content in wt % |
|---|---|
| Al₂O₃ | 81.0 |
| SiO₂ | 10.9 |
| TiO₂ | 0.01 |
| Fe₂O₃ | 0.14 |
| CaO | 0.14 |
| K₂O | 0.15 |
| MgO | 0.02 |
| MnO | <0.01 |
| Na₂O | 0.48 |
| Li₂O | 0.54 |
| Cr₂O₃ | <0.01 |
| P₂O₅ | 6.54 |
| SO₃ | <0.01 |
| ZnO | 0.01 |
| ZrO₂ | <0.01 |
| Total | 100 |
| Loss on ignition | 0.14 |

The composition was determined using RFA, calculated on annealed material.

### Example 3

An example of a slip for a further foam ceramic according to an embodiment, here comprising B₂O₃, Li₂O, and SiO₂, is given in the following table:

| | | |
|---|---|---|
| Inorganic binder | 17% | Colloidal SiO₂ (silica sol) |
| Rheological additive | 3% | Bentonite |
| Organic binder | 1.3% | Butyl methacrylate copolymer |
| Main material | 52% | Calcined alumina (Al₂O₃) |
| Secondary material | 10% | Petalite |
| Inorganic binder | 7% | Boron glass |
| Inorganic binder | 0.6% | Acid |

| | |
|---|---|
| Liquefier | 0.1% |
| Water | 9.0% |

Filters according to embodiments of the present disclosure were used to perform various casting tests, which also included a determination of the hydrogen content in the aluminum melt upstream and downstream of the filter. This was in particular done using filters that contained lithium, i.e. designed to getter hydrogen. The results of this gettering are briefly summarized below:

At the start of casting, the hydrogen content upstream of the filter was 0.502 ml per 100 g of aluminum, and was 0.321 ml per 100 g of aluminum downstream of the filter box. Towards the end of the casting, the content upstream of the filter box was 0.474 ml per 100 g of aluminum, and was 0.343 ml per 100 g of aluminum downstream of the filter box. The casting duration was about 130 minutes at a flow rate of 26 kg per minute. Alloy 5083 (Mg 4.5) was cast.

Hence, the hydrogen reduction by virtue of the lithium-containing filter is of the same order of magnitude as the one obtained by a degasser (cf. also the above discussion of results from Chenisola et al.).

### DESCRIPTION OF THE DRAWINGS

The invention will now be explained in more detail with reference to the figures, wherein:

FIGS. 1 to 3 show XRD plots of different foam ceramics, and

FIG. 4 shows dilatometer curves of different foam ceramics.

FIG. 5 is a schematic cross-sectional view of a foam ceramic.

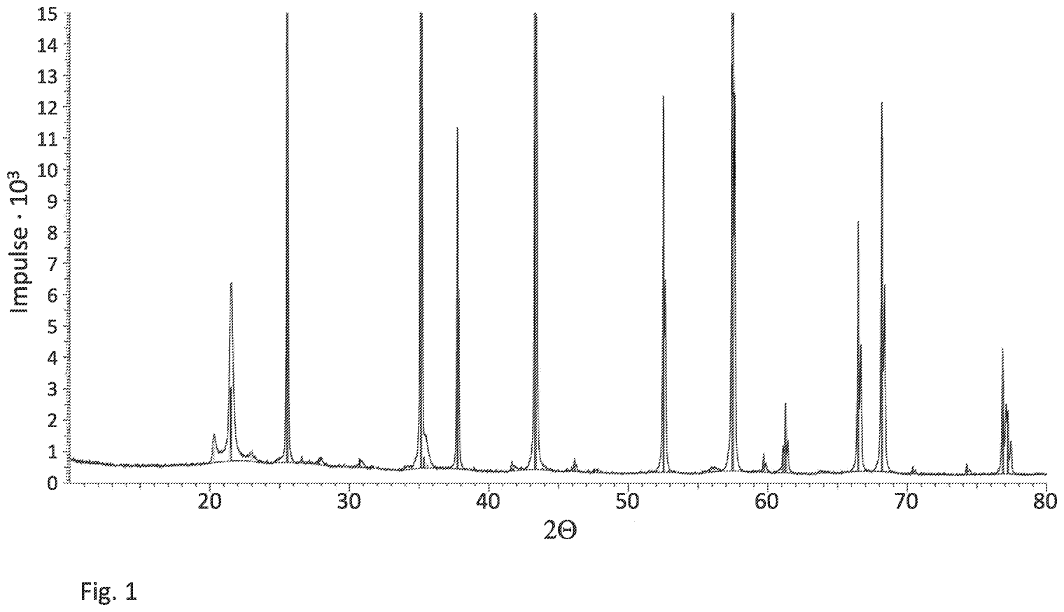

FIG. 1 shows a first XRD plot of a first conventional phosphate-bonded foam ceramic. Quantitative evaluation of this diffractogram reveals a phase content of 90.5 vol % of α-Al₂O₃ (corundum), 6.4 vol % of SiO₂ (cristobalite), 2.8 vol % of AlPO₄, and 0.2 vol % of SiO₂ (quartz). The phase content of amorphous material, which is estimated from the formation of an elevated background of reflected X-rays in the 20 angle range up to about 30°, is very low here.

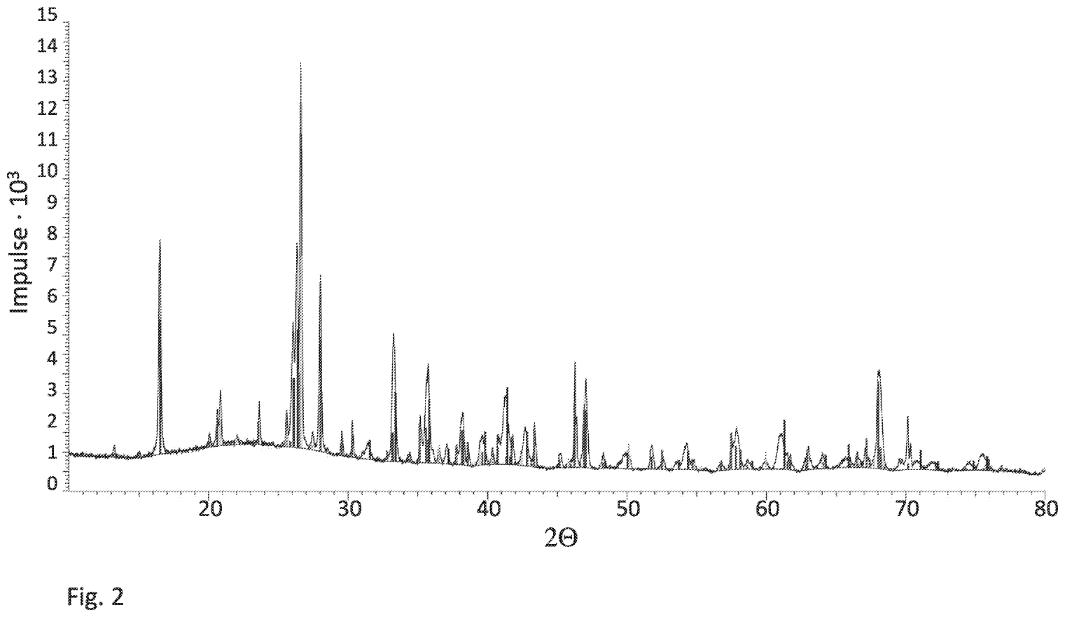

FIG. 2 shows an XRD plot of a commercially available SiO₂-bonded filter material. Evaluation reveals that this material comprises only 5.8 vol % of Al₂O₃ in the form of corundum and 0.4 vol % of SiO₂ in the form of cristobalite. Since this is not a phosphate-bonded filter material, no AlPO₄ can be detected. The content of SiO₂ in the form of quartz is 6.7 vol % here, which is higher than in phosphate-bonded foam ceramics. Furthermore, the foam ceramic comprises 34.2 vol % of Al₂SiO₅ in the form of kyanite, and 52.9 vol % of boromullite with an assumed composition of Al_{4.5}Si_{0.9}B_{0.6}O_{9.4}. What is noticeable, in addition to the very different phase content compared to conventional phosphate-bonded foam ceramics and the occurrence of phases that are not present in phosphate-bonded foam ceramics, is a significantly increased content of amorphous material (visible as an “amorphous hump” in particular in the 2θ angle range between 16° and

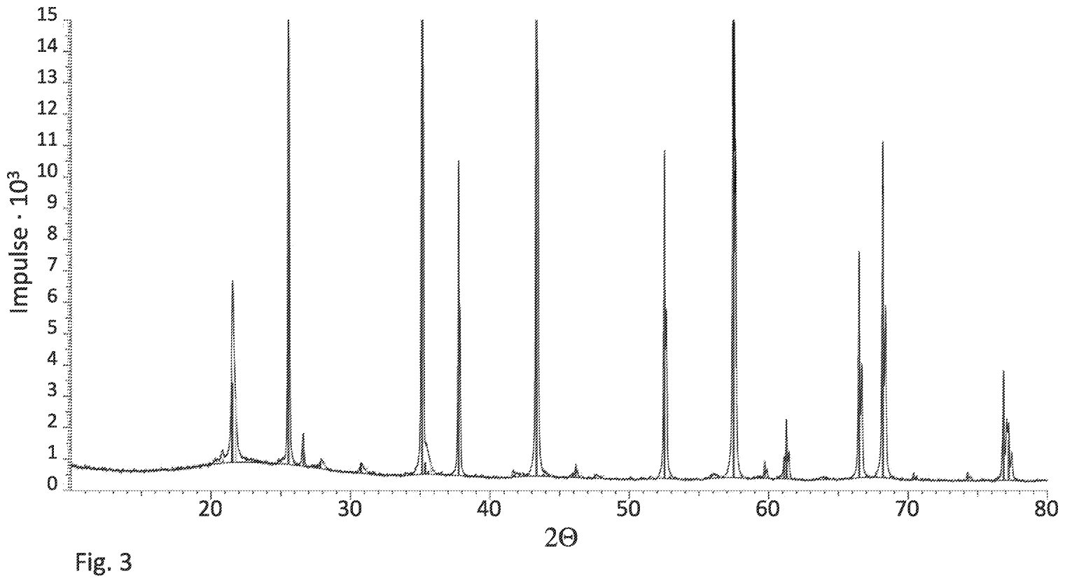

FIG. 3 shows an XRD plot of a foam ceramic according to an embodiment, which corresponds to example 2 according to the present application. This is a foam ceramic which comprises P₂O₅ and Li₂O. Evaluation of the diffractogram reveals a phase content of 90.4 vol % of Al₂O₃, 1.6 vol % of SiO₂ (cristobalite), and 6.9 vol % of AlPO₄, and 1.1 vol % of SiO₂ (quartz). The background of the diffractogram in the 20 angle range up to 30° is slightly higher than in the diffractogram of FIG. 1. Hence, the amorphous phase content is somewhat higher here than in a conventional phosphate-bonded foam ceramic. However, shifts in phase content are apparent in the form that the material according to an embodiment of the present disclosure includes less cristobalite, but slightly more quartz, and significantly more crystalline AlPO₄. Surprisingly, no crystalline phase comprising Li₂O is detectable in the diffractogram. The inventors assume that Li₂O is present as a constituent of the amorphous phase which is increased in comparison with conventional phosphate-bonded foam ceramics. Such a filter material exhibits particularly good strength, in particular snowing is further reduced in comparison to a conventional phosphate-bonded foam ceramic, for example.

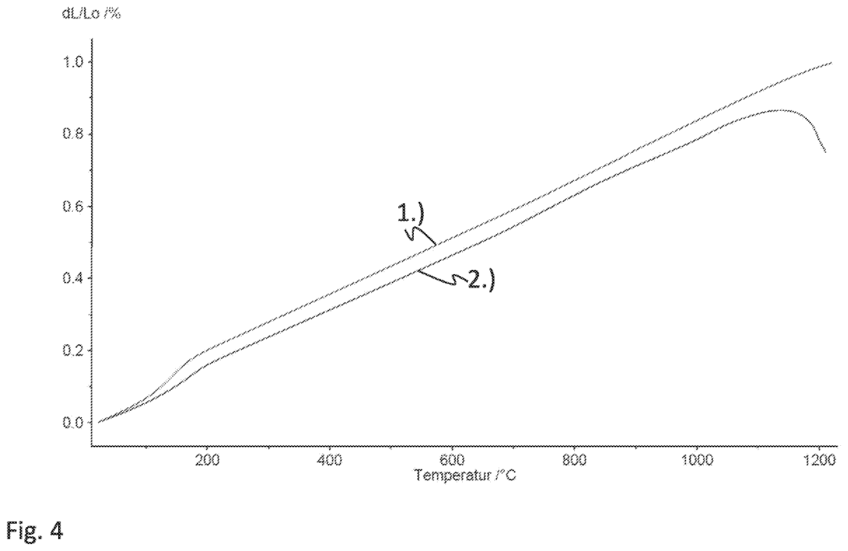

It is also surprising that this material, despite the crystallographically detectable greater phase content of AlPO₄, nevertheless exhibits a smaller jump in volume during production than the conventional phosphate-bonded filter material. This is particularly surprising since this jump in volume of usually about 2-3% is attributable to the transformation of berlinite or AlPO₄ at about 200° C. FIG. 4 shows dilatometer curves (obtained according to DIN 51045-1:2005-08 and DIN 51045-2:2009-04, although, other than in the standard, the heating rate was 10 K/min here) for a conventional phosphate-bonded foam ceramic denoted by 1.) here (corresponding to the foam ceramic characterized in FIG. 1), and for a foam ceramic according to an embodiment denoted by 2.) here, which corresponds to the foam ceramic characterized in FIG. 3 in terms of its phase content. As can be seen, the jump in volume at about 200° C., which indicates a phase transformation at 200° C., is significantly reduced in the foam ceramic 2.) according to an embodiment.

The reason for this is not fully understood. However, the inventors assume that this could possibly be due to the chemical composition of the matrix in particular, possibly also due to the fact that the matrix for foam ceramics according to the present disclosure has a greater content in amorphous phase than a conventional phosphate-bonded foam ceramic. However, not only the presence of an amorphous phase alone seems to be of importance, but also a suitable chemical composition. This is because the lower jump in volume for a foam ceramic according to embodiments leads to improved strength, which is also reflected in less chalking of the foam ceramic, among other things. It is true that the non-phosphate-bonded foam ceramic shown in FIG. 2 also has an amorphous phase, in particular also with a larger proportion than the foam ceramic characterized in FIG. 3 or curve 2 of FIG. 4 according to an embodiment. However, such a foam ceramic is characterized by a rather low strength, which is also apparent from a strong particle release. It is precisely the combination of a suitable composition of the foam ceramic, in particular also of the matrix, and the generation of suitable crystalline phases that the advantageous properties of foam ceramics according to embodiments result.

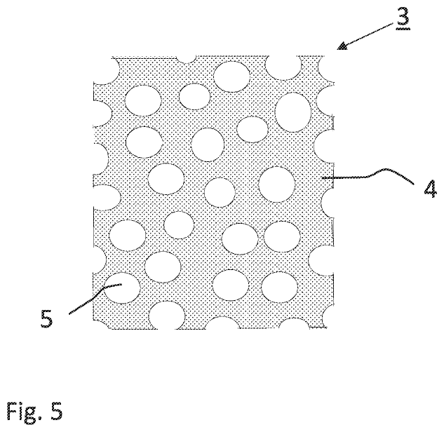

FIG. 5 shows a schematic cross-sectional view of a foam ceramic 3 according to an exemplary embodiment. The foam ceramic 3 comprises a solid phase 4 and pores 5.

1. A foam ceramic, comprising
a base material comprising Al₂O₃ and preferably Li₂O; and
a matrix comprising SiO₂ and/or B₂O₃ and/or P₂O₅ and/or Li₂O and/or CaO;
wherein the coefficients of thermal expansion of the base material preferably differ from the coefficients of thermal expansion of the matrix by at most 6*10⁻⁶/K.

2. A foam ceramic, comprising
a base material comprising Al₂O₃; and
a matrix comprising SiO₂;
in particular a foam ceramic according to claim 1,
wherein the foam ceramic comprises more than 15 wt % of SiO₂, and at most 25 wt % of SiO₂.

3. A foam ceramic, comprising
a base material comprising Al₂O₃; and
a matrix comprising SiO₂;
in particular a foam ceramic according to claim 1;
wherein the foam ceramic has a content of B₂O₃ of at most 500 ppm by weight.

4. The foam ceramic according to claim 1, wherein the foam ceramic comprises Li₂O, wherein the Li₂O content of the foam ceramic is at least 0.3 wt % and at most 5 wt %.

5. The foam ceramic according to claim 1, comprising at least 0.1 wt % of CaO and at most 20 wt % of CaO.

6. The foam ceramic according to claim 1, comprising at least 67 wt % of Al₂O₃ and at most 95 wt % of Al₂O₃.

7. The foam ceramic according to claim 1, comprising at least 75 wt % of Al₂O₃ and at most 95 wt % of Al₂O₃.

8. The foam ceramic according to claim 1, comprising at least 5 wt % of SiO₂ and at most 25 wt % of SiO₂.

9. The foam ceramic according to claim 1, comprising between at least 0.1 wt % of B₂O₃ and at most 5 wt % of B₂O₃.

10. The foam ceramic according to claim 1,
wherein the foam ceramic is free of P₂O₅, apart from unavoidably traces; or
wherein the foam ceramic is in the form of a phosphate-bonded foam ceramic, with a content of P₂O₅ in the foam ceramic of at most 10 wt % and preferably at least 5 wt %; and wherein the foam ceramic preferably comprises Li₂O as a constituent of the matrix.

11. The foam ceramic according to claim 1, wherein the foam ceramic comprises at least 0.1 wt % of CaO and at most 20 wt % of CaO.

12. The foam ceramic according to claim 1, wherein the base material comprises α-Al₂O₃.

13. The foam ceramic according to claim 1, wherein the matrix is at least partially glassy.

14. The foam ceramic according to claim 1, wherein the base material is present in particulate form.

15. The foam ceramic according to claim 1, wherein the matrix comprises Li₂O, preferably a lithium-containing silicate glass and/or a lithium-containing borate glass.

16. The foam ceramic according to claim 1, comprising the following constituents, in wt %:
Al₂O₃ 67 to 95
Li₂O 0 to 5
SiO₂ 0 to 25
B₂O₃ 0 to 5, and/or with a content of B₂O₃ of at most 500 ppm by weight
CaO 0 to 20
P₂O₅ 0 to 10.

17. The foam ceramic according to claim 1, comprising the following constituents, in vol %, based on the solids content:
α-Al₂O₃ (corundum) 85 to 95
Quartz 0.8 to 2
Cristobalite 0 to 2.

18. The foam ceramic according to claim 1, having a coefficient of linear thermal expansion of at least 7*10⁻⁶/K and at most 9*10⁻⁶/K.

19. A method for producing a foam ceramic, in particular a foam ceramic according to claim 1, comprising the steps of
providing a preferably aqueous slip comprising a starting material comprising Al₂O 3 and a starting material comprising SiO₂ and/or B₂O₃ and/or P₂O₅ and/or Li₂O and/or CaO;
soaking an open-cell foam, in particular an open-cell polymer foam, with the slip, so as to obtain a foam coated with the slip;
drying the foam so as to obtain a green body of a foam ceramic;
preferably coating the dried green filter, spraying viscous sprayable slip onto the dried green filter;
preferably burning out the polymer foam; and
sintering the green body to obtain a foam ceramic.

20. The method according to claim 19, wherein the slip comprises a silicate glass frit and/or a borate glass frit, and wherein the glass frit preferably comprises Li₂O as a constituent.

21. The method according to claim 19, wherein the slip comprises a lithium-containing starting material, wherein the glass is a silicate glass.

22. A filter for filtering melts of non-ferrous metals, in particular melts of light metals, wherein the filter comprises a foam ceramic according to claim 1.
